(19) United States
(12) Patent Application Publication
(10) Pub. No.: US 2011/0113563 A1
(43) Pub. Date: May 19, 2011

(54) Power-Assisted Tire Changing Kit

(76) Inventor: Anthony A. Gabb, Jamaica, NY (US)

(21) Appl. No.: 12/939,109

(22) Filed: Nov. 3, 2010

Related U.S. Application Data
(60) Provisional application No. 61/281,167, filed on Nov. 13, 2009.

(51) Int. Cl. B60B 29/00

(52) U.S. Cl. 7/100

(57) ABSTRACT

The first embodiment of the discloser presents herein is a power-assisted tire changing kit that is comprised of a commercially available 12-volt electric impact wrench, three impact wrench adapters that mate the electric impact wrench to three scissors jack designs, and a set of lug nuts sockets that match the electric impact wrench with various size lug nuts. A pair of gloves and a soft case that holds the other components complete the embodiment. Other embodiments are presented that have different or additional accessories, or are customized to a specific vehicle model.

### CROSS-REFERENCE TO RELATED APPLICATIONS

This application claims the benefit of the U.S. Provisional Patent Application No. 61/281,167 filed Nov. 13, 2009 by the present inventor. This provisional patent application is incorporated herein by reference.

### TECHNICAL FIELD

The invention presented herein applies to power assisted kits used for both operating a vehicle scissors jack and for the removal and tightening of wheel lug nuts.

### BACKGROUND OF THE DISCLOSURE

There are many devices that assist a user in changing a tire. The vehicle is typically equipped with a scissors jack with a screw rotating device and a manual lug nut remover. Improvements to this basic capability come in various forms. Some of these improvements are very complex, such as equipping the vehicle (or a kit) with an air compressor that drives an air driven impact wrench. Other improvements provide an impact wrench (air or electrical) that has a speed reducer and an impact wrench adapter that allow the impact wrench to be used with a jack. Still other improvements provide a new jack with an electrical motor built in. However there is a need for a simple power-assisted kit that facilitates the changing of a tire using inexpensive components.

### SUMMARY OF THE DISCLOSURE

This invention solves the problem of providing a kit that provides one or more power assisted devices that make the changing of a vehicle's tire less strenuous, is compatible with vehicle tire changing accessories that come with the vehicle, and may be sold at a low cost. A first embodiment of the invention is comprised of an electric impact wrench that is driven by a vehicle's 12-volt power supply such as a 12-volt accessory socket, one or more lug nut sockets compatible with the electric impact wrench, one or more impact wrench adapters that connect the electric impact wrench to various versions of standard scissors jacks, and one or more additional items such as a warning reflective triangle, a flashlight, a kneeling pad, work gloves, and an instruction manual. In the first embodiment a set of lug nut sockets and a set of impact wrench adapters are selected to work with a large range of vehicles. Other embodiments reduce the amount of required components significantly by customizing the kit to work with a specific vehicle model's lug nut and jack.

What is novel is that the embodiments of the inventive concept presented herein provide various versions of an inexpensive power-assisted tire changing kit that uses a vehicle's 12-volt power supply and may be configured to apply to original vehicle equipment, or apply to a large segment of the vehicle aftermarket.

### BRIEF DESCRIPTION OF THE DRAWINGS

FIG. 1A illustrates a perspective view of a scissors jack.

FIG. 1B illustrates a jack rotator tool.

FIG. 1C illustrates a lug nut wrench.

FIG. 2A illustrates a 12-volt electric impact wrench.

FIG. 2B illustrates a set of lug nut sockets.

FIGS. 3A1 and 3A2 illustrate two alternate versions of an impact wrench adapter matched to a version of a jackscrew connector part.

FIG. 3B illustrates an alternate version of a jack rotator tool connector part matched to an alternate version of an impact wrench adapter.

FIG. 3C illustrates an alternate version of an impact wrench adapter matched to an alternate version of an alternate version of a jack rotator tool connector part.

FIG. 3D is a cross section of FIG. 3C.

FIG. 4A illustrates an alternate version of an impact wrench adapter matched to an alternate version of a jack rotator tool connector part.

FIG. 4B illustrates an alternate version of a jack rotator tool connector part matched to an alternate version of an impact wrench adapter 200B.

FIG. 5A illustrates an alternate version of an impact wrench adapter matched to an alternate version of a jack rotator tool connector part.

FIG. 5B illustrates an alternate version of an impact wrench adapter matched to an alternate version of an impact wrench adapter.

FIG. 6 illustrates an electric impact wrench with four matched lug nut sockets and three versions of impact wrench adapters.

FIG. 7 illustrates an embodiment of electric impact wrench matched to a jackscrew connector part customized for a specific vehicle model.

FIG. 8 illustrates several optional accessories for the power-assisted tire changing kit.

FIG. 9 illustrates a power-assisted tire changing kit with a soft case.

### DETAILED DESCRIPTION

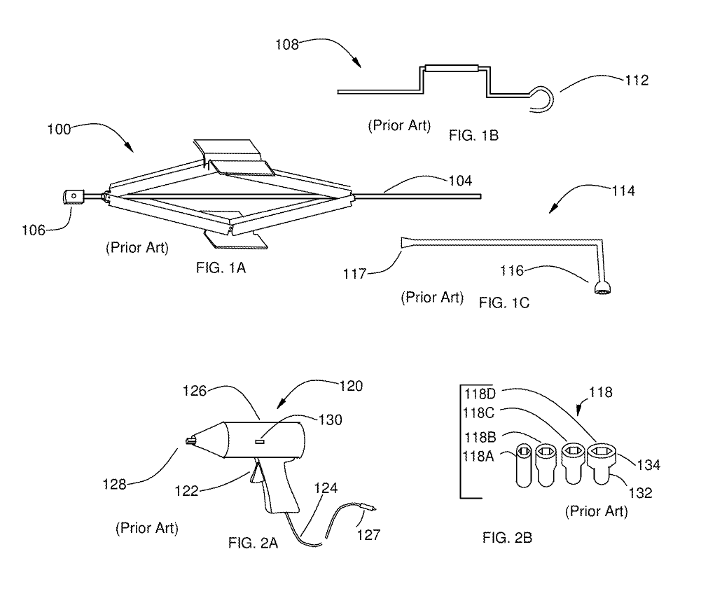

FIGS. 1A through 1C illustrate a typical set of prior art equipment for changing a tire that comes with a vehicle such as an automobile or truck. The standard equipment is comprised of three components. The first component, illustrated in FIG. 1A, is a scissors jack 100 that raises and lowers the vehicle. Scissors jack 100 has a jackscrew connector part 106A of a jackscrew 104 that attaches to a jack rotator tool connector part 112 of a jack rotator tool 108.

The second component, illustrated in FIG. 1B, is jack rotator tool 108 having jack rotator tool connector part 112 that removably attaches to jackscrew connector part 106A on jackscrew 104, and when rotated in a first rotational direction raises the jack, and when rotated in a second rotational direction lowers the jack.

The third component, illustrated in FIG. 1C, is a lug nut wrench 114 approximately L-shaped that has a socket 116 on one end that fits on a lug nut (not illustrated in the figure) and is used for loosening and tightening lug nuts on a wheel, and also has a tapered extension 117 located on a second end that aids in the removal of a hub cap.

FIGS. 2A and 2B illustrate a commercially available 12-volt electrical impact wrench kit consisting of an electric impact wrench and a set of lug nut sockets. FIG. 2A illustrates an electric impact wrench 120. It has a trigger 122 for operating the electric impact wrench 120, a power cord 124 that is attached to the case 126 of the electric impact wrench. The power cord 124 has a plug 127 that is received by a 12-volt accessory power source inside the vehicle that provides power to electric impact wrench 120. Electric impact wrench 120 has a drive shaft 128 that rotates in a first direction when a switch 130 is set in a first position and rotates in a second direction when the switch is set in a second position. Referring to FIG. 2B, the electric impact wrench kit typically comes with a set of one or more lug nut sockets 118, each socket has a driver shaft end 132 that removably attaches to the drive shaft 128 and has a lug nut end 134 that fits over a lug nut. FIG. 2B illustrates four lug nut sockets 118A, 118B, 118C and 118D. The lug nut sockets 118 are sized so they fit over common lug nuts typically found on vehicles, e.g. 11/16″, ¾″, 13/16″, and ⅞″ that fit most automobile lug nuts. An example of a low cost electric impact wrench is a Chicago Electric Power tools 12 Volt ½ drive electric impact wrench that delivers 140 ft. lbs of torque and is available at retail at HarborFreight.com for considerably under $50 dollars at the time of this writing.

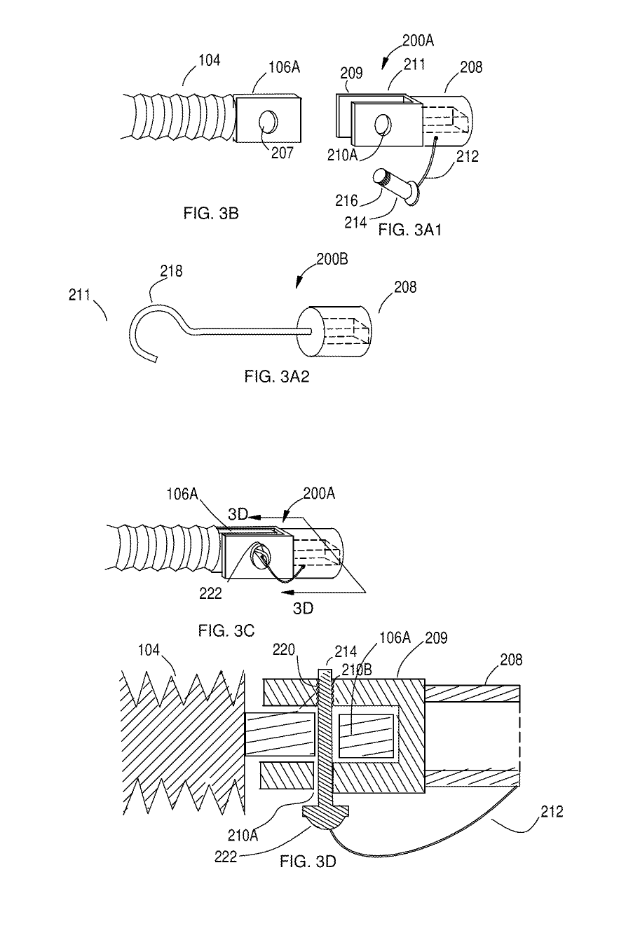

FIGS. 3A1, 3A2, 4A and 5A illustrate four versions of an impact wrench adapters 200A, 200B, 200C, and 200D and that are designed to removably mate scissors jack 100 to electric impact wrench 120. Jackscrew connector part 106A on scissors jack 100 as illustrated in FIG. 1 is just one example of several connector part designs. Referring to FIGS. 3A1 and 3B, jackscrew connector part 106A of a first version of a scissors jack is a thin rectangular plate attached to the end of jackscrew 104 of the jack. Jackscrew connector part 106A has a circular hole 207 centrally positioned and passing through the plate transverse to the screw's longitudinal axis.

Referring now to FIGS. 3A1 and 3B, impact wrench adapter 200A is comprised of two permanently attached parts, an impact wrench socket end 208, designed to mate to drive shaft 128 of electric impact wrench 120, and a jackscrew connector part end 211. Jackscrew connector part end 211 is comprised of a U-shaped impact wrench adapter connector part 209, designed to be removably mated to jackscrew connector part 106A forming a male (connector part)/female (adapter) connector. U-shaped impact wrench adapter connector part 209 has a first circular hole 210A going through a first parallel side and a threaded circular hole 210B going through a second parallel side (threaded circular hole 210B is not visible in FIG. 3A1) and a bolt 214. A swivable chain 212 is permanently attached to impact wrench socket end 208 on one end and of the impact wrench adapter 200A and attached to a tab (222 illustrated in FIG. 3D) on bolt 214 so that the bolt can rotate. Bolt 214 has threads 216 on one end that mate with threads located on the back circular hole on the U-shaped impact wrench adapter connector part 209.

FIG. 3C illustrates impact wrench adapter 200A mated to jackscrew connector part 106A. Bolt 214 has a tab 222 on its non-threaded end so the bolt can be turned by hand. The cross section 3D illustrated in FIG. 3C is taken along the screw adapter's longitudinal axis and bisects the impact wrench adapter 200A.

FIG. 3D illustrates in larger scale the cross section 3D of FIG. 3C wherein impact wrench adapter 200A is mated to jackscrew connector part 106A, with bolt 214 securing the mated components to each other. Bolt 214 has threads 216 that engage the matching threads 220 located on a threaded circular hole 210B that secures the bolt. Bolt 214 also has a tab 222 for turning the bolt.

FIG. 3A2 illustrates impact wrench adapter 200B with a jackscrew connector part end 211 that mates with jackscrew connector part 106A. Jackscrew connector part end 211 has a hook 218 instead of the U-shaped impact wrench adapter connector part 209, but otherwise works similarly. Impact wrench socket end 208 connect to the drive shaft 128 of electric impact wrench 120. Both impact wrench adapters 200A and 200B work with jackscrew connector part 106A. Impact wrench adapter 200A may be permanently attached to the scissors jack while impact wrench adapter 200B cannot. Note that impact wrench adapter 200B functions as a male impact wrench adapter; while jackscrew connector part 106A functions as a female connector. Impact wrench adapter 200A is more complex than impact wrench adapter 200B, but has the advantage that it may be permanently attached to a matching scissors jack.

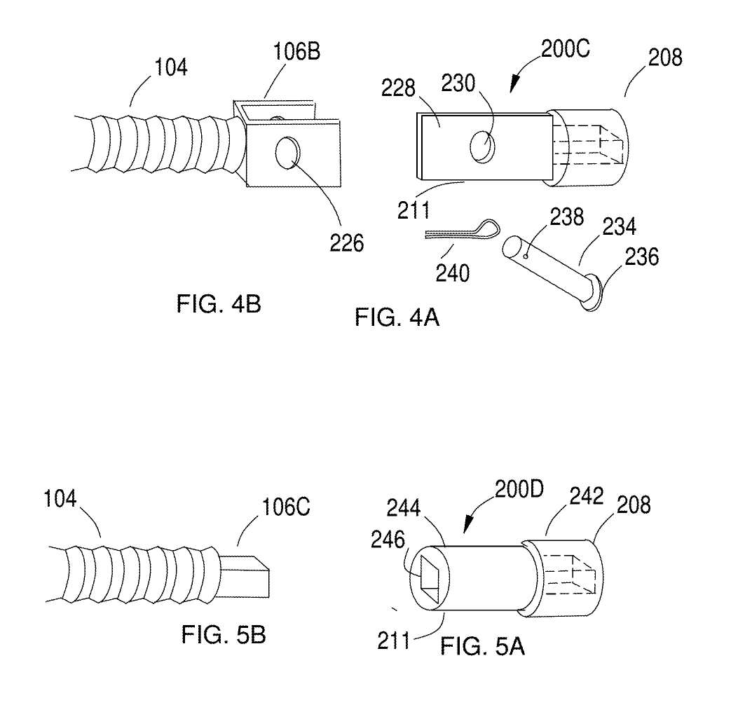

FIG. 4A illustrates a third version 200C of an impact wrench adapter. It has a male jackscrew connector part 228 that is designed to mate to a scissors jack that has a female jackscrew connector part 106B illustrated in FIG. 4B. A bolt 234 connects impact wrench adapter 200C to female jackscrew connector part 106B by mating the impact wrench adapter 200C to the connector and passing the bolt 234 through the circular hole 226 on the first parallel side of female jackscrew connector part 106B, then through the circular hole 230 on male jackscrew connector part 228, and finally through a second circular hole on female jackscrew connector part 106B. The second circular hole is not visible in FIG. 4B. Bolt 234 has a head 236 on one end and a circular hole 238 passing traversly through the bolt located towards the second end of the bolt. A cotter pin 240 is used to secure the bolt when impact wrench adapter 200C and female jackscrew connector part 106B are mated.

FIG. 5A illustrates a fourth version of impact wrench adapter 200D. It has a first end 242 that 208, designed to mate to drive shaft 128 of electric impact wrench 120, and a second end 244 that has a square socket cavity 246. Impact wrench adapter 200D is designed to mate with a scissors jack that has a male jackscrew connector part 106C shaped as a rectangular shaft with a square cross section.

The term “matched” is defined in this specification and in the appended claims as follows. If a set of lug nut sockets is each designed to mate at the lug nut end with a set of lug nuts, each of a different size, then the set of lug nut sockets is defined to be matched to the set of lug nuts. If the same set of lug nut sockets is each designed to mate at the apposing end with the driver shaft end of the same electric impact wrench, the set of lug nut sockets is defined to be matched to the impact wrench. Similarly, if a set of impact wrench adapters is each designed to mate at the jackscrew connector part end with a set of jackscrews, each jackscrew having a jackscrew connector part of a different design, then the set of impact wrench adapters is defined to be matched to the set of jackscrews. If the same set of impact wrench adapters is each designed to mate at the end apposing the jackscrew connector part end with the drive shaft of the same electric impact wrench, then the set of jackscrew connector parts is defined to be matched to the impact wrench.

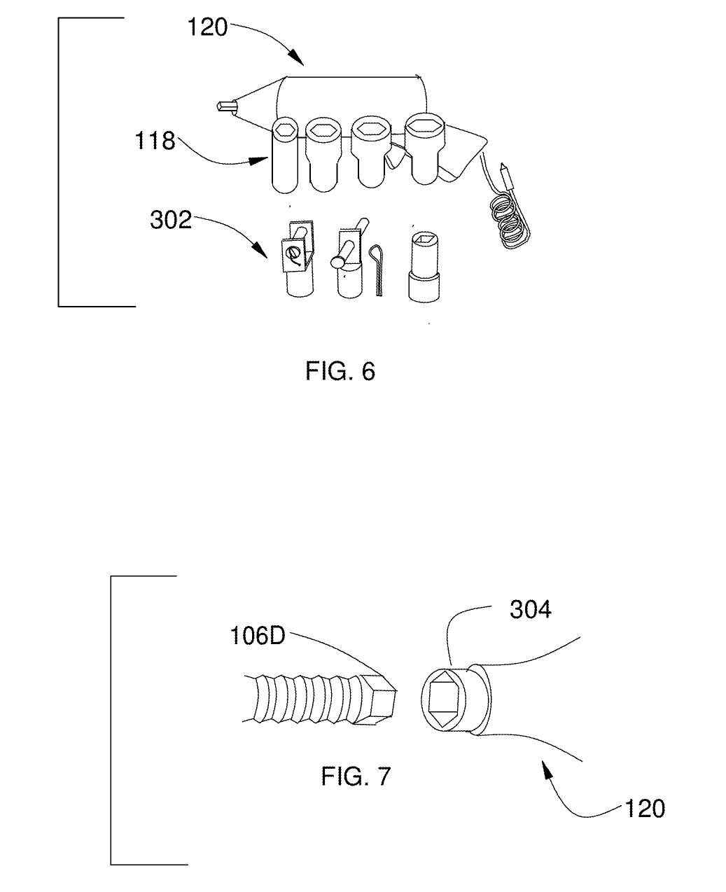

FIG. 6 illustrates a first embodiment of the components of a power-assisted tire changing kit. The kit is comprised of an electric impact wrench 120 powered off a vehicle's 12-volt power accessory socket, a set of four lug nut sockets 118 of different sizes matched to the electric impact wrench, and a set of three impact wrench adapters 302 matched to the electric impact wrench, with each impact wrench adapter matched to a scissors jack with a different jack rotator design. These items, together with a case that stores the item (the case is not illustrated in FIG. 6), represent a low-cost power-assisted tire changing kit. If the first embodiment is available to a user, it functions as a complete power-assisted tire changing kit that may be used with a large range of vehicles.

The power-assisted tire changing kit described in embodiment one has a multitude of variations that can meet various price-points and apply to a wide variety of vehicle situations. For example, referring to FIG. 6, another embodiment is a kit that is designed to be used with a specific vehicle model. This embodiment needs only one lug-nut socket 118 that fits the lug nut on the wheels that comes with the vehicle. It also has only one impact wrench adapter that fits jackscrew connector part 106A of the scissors jack that comes with the vehicle. Furthermore, the vehicle no longer needs jack rotator tool 108; and lug nut wrench 114 that is provided with the vehicle may be eliminated. If the vehicle has hubcaps, then a simpler device such as a screwdriver may be included to aid in the removal of hubcaps.

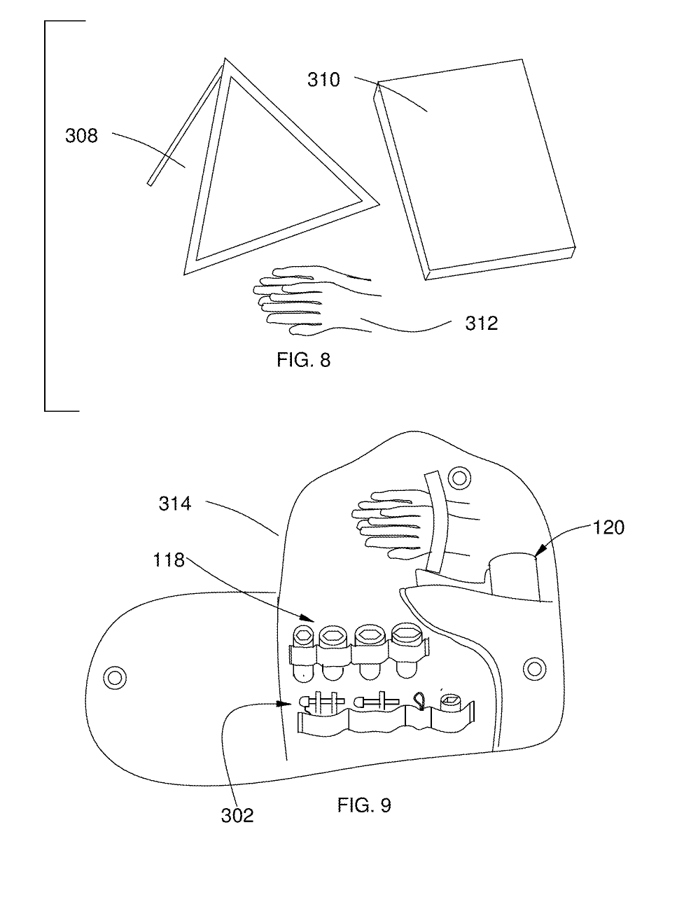

An even further simplification is possible when customized for a particular vehicle model. FIG. 7 illustrates another embodiment that applies nicely to new vehicle equipment as well as aftermarket equipment. In this embodiment, electric impact wrench 120 has its drive shaft 128 replaced by a lug nut socket 304 that is permanently attached and fits the lug nuts 306 used on the vehicle model's wheels, and also has a customized scissors jack so that jackscrew connector part 106D is designed to mate with lug nut socket 304. For this embodiment, only the modified jack, the modified electric impact wrench and a hubcap removal tool is required.

FIG. 8 illustrated additional items that may be added to the power assisted tire changing kit. Illustrated in FIG. 8 are a collapsible triangular reflector 308, a pair of gloves 312, and a kneeling pad 310. Other items that may be included such as an oil dispenser for loosening the lug nuts, an instruction book, a flashlight, a flare, blocks for preventing the vehicle from rolling, and an instructional video.

FIG. 9 illustrates one configuration of a power-assisted tire changing kit. It includes a case 314 that stores the electric impact wrench, four lug nut sockets 118, three different impact wrench adapter versions, and a pair of gloves 312. Case 314 is made of a flexible material such as vinyl or leather and will fit inconspicuously in the wheel-well or an auxiliary pocket in a trunk of an automobile. Depending on the actual items included in the power-assisted tire changing kit, the case may be either made of a flexible material or be a hard case similar to a suitcase.

To use the power-assisted tire changing kit for loosening or tightening a lug nut, the lug nut socket is matched to the electric impact wrench and to the lug nuts of the vehicle's wheels. The electric impact wrench with the matched lug nut socket is used to loosen or tighten the lug nut in the usual manner. To use the power-assisted tire changing kit with a scissors jack for raising or lowering a vehicle, an impact wrench adapter from the kit is selected that matches the scissors jack. Then, the scissors jack is placed under the vehicle in the usual manner for raising or lowering a vehicle while changing a tire on a vehicle. The electric impact wrench with the matched impact wrench adapter is mated to the scissors jack and operated so that it rotates the screw on the scissors jack in the desired direction to either raise or lower the vehicle. Tests on using the electric impact wrench with a scissors jack as described in this specification for raising the jack to its desired height for changing a tire takes about five minutes, and lowering the jack takes about a minute and a half. Although the process is noisy due to the hammering effect of the electric impact wrench, using the electric impact wrench with the jack works easily.

The disclosure presented herein gives several embodiments of the invention. These embodiments are to be considered as only illustrative of the invention and not a limitation of the scope of the invention. Various permutations, combinations, variations and extensions of these embodiments are considered to fall within the scope of this invention. For example, it may include other designs of impact wrench adapters than those presented in this specification. The jack may be a hydraulic jack. The electric impact wrench may be replaced by a powerful 12-volt drill. The electric impact wrench may have a drive other than ½ inch. The power cord inserted in the vehicle's 12-volt external power socket may be replaced or supplemented by a power cord that attaches to the vehicle's battery. A large set of sockets and impact wrench adapters may be used. Therefore the scope of this invention should be determined with reference to the claims and not just by the embodiments presented herein.

What is claimed is:

1. A kit for changing a tire of at least three vehicles, each vehicle having a scissors jack of a different jackscrew connector part design, the kit comprising in combination:
an electric powered impact wrench, the electric powered impact wrench having a power connector that connects to the electric power system of at least one vehicle;
at least three lug nut sockets, each lug nut socket matched to a lug nut of a different size, and furthermore each lug nut socket matched to the electric impact wrench.
at least three impact wrench adapters, each impact wrench adapter matched to the electric impact wrench, and additionally each impact wrench adapter matched to a scissors jack having a different jackscrew connector part design; and
at least one accessory selected from the group consisting of a case, a pair of gloves, a kneeling mat, an instruction manual, a reflector, and a combination thereof.

2. A kit for changing a tire of at least three of vehicles of claim 1 wherein one of the impact wrench adapters is comprised of a U-shaped part comprised of a first side and a second side, the U-shaped adapter having a first circular hole passing through the first side, and a second circular hole passing through the second side, the second circular hole being threaded, a pin with a head on a first end and threads on the second end matched to the threads of the second circular hole, and a flexible connector wherein the flexible connector flexibly attaches the pin to the impact wrench adapter, and such that the pin removably passes through the first circular hole and may be removably secured using the threads of the second circular hole.

3. The kit for changing a tire of at least three vehicles of claim 1 wherein:
one of the impact wrench adapters is comprised of a flat bar, the flat bar having a first hole passing through the bar;
a securing pin having a head on a first end and a second hole near a second end, the securing pin configured to pass through the first hole;
a securing means such that the securing pin removably passes through the first circular hole and may removably secure the securing pin to the flat bar.

4. The kit for changing a tire of at least three vehicles of claim 3 wherein securing means is a cotter pin matched to the second hole.

5. The kit for changing a tire of at least three vehicles of claim 1 wherein one of the impact wrench adapters is comprised of a cylindrical part, the cylindrical part having a rectangular cavity such that the longitudinal axis of the rectangular cavity coincides with the longitudinal axis of the cylindrical part.

6. The kit for changing a tire of at least three vehicles of claim 1 wherein one of the impact wrench adapters is comprised of a hook.

7. The kit for changing a tire of at least three vehicles of claim 1 wherein the power connector connects to the accessory power socket of the vehicle.

8. The kit for changing a tire of at least three vehicles of claim 1 wherein the power connector connects to the battery terminals of the vehicle.

9. A kit customized for a specific vehicle class, the vehicle having a scissors jack and a wheel with lug nuts, the kit comprising in combination:
an electric impact wrench;
a lug nut socket matched to the electric impact wrench and also matched to the lug nut;
an impact wrench adapter matched to the electric impact wrench and also matched to the scissors jack; and
at least one accessory selected from the group consisting of a case, a pair of gloves, a kneeling mat, an instruction manual, a reflector, and a combination thereof.

10. A kit customized for a vehicle with a wheel having a lug nut and a scissors jack comprising:
an electric impact wrench;
a scissors jack; and
at least one accessory selected from the group consisting of a case, a pair of gloves, a kneeling mat, an instruction manual, a reflector, and a combination thereof;
wherein the electric impact wrench is matched to the lug nut and furthermore the electric impact wrench is matched to the scissors jack.
